(19) United States
(12) Patent Application Publication
(10) Pub. No.: US 2022/0276181 A1
(43) Pub. Date: Sep. 1, 2022

(54) SURFACE ANOMALY DETECTING DEVICE, SYSTEM, METHOD, AND NON-TRANSITORY COMPUTER-READABLE MEDIUM

(71) Applicant: NEC Corporation, Minato-ku, Tokyo (JP)

(72) Inventors: Yoshimasa ONO, Tokyo (JP); Akira TSUJI, Tokyo (JP); Junichi ABE, Tokyo (JP)

(73) Assignee: NEC Corporation, Minato-ku, Tokyo (JP)

(21) Appl. No.: 17/635,523

(22) PCT Filed: Aug. 26, 2019
(86) PCT No.: PCT/JP2019/033294

§ 371 Date: Feb. 15, 2022

(51) Int. Cl. G01N 21/95; G01S 17/89

(52) U.S. Cl. CPC G01N 21/9515; G01S 17/89

(57) ABSTRACT

The present disclosure is directed to providing a surface anomaly detecting device, a system, a method, and a non-transitory computer-readable medium that can identify an anomalous portion on a surface of a complex structure. A surface anomaly detecting device according to the present disclosure includes: dividing means configured to divide a structure into a plurality of clusters based on position information of a plurality of points on a surface of the structure; coupling means configured to create a cluster group by coupling together two or more of the clusters; determining means configured to determine a reflection luminance normal value of the cluster group based on a distribution of reflection luminance values at a plurality of points on a surface of the cluster group; and identifying means configured to identify an anomalous portion on the surface of the cluster group.

### TECHNICAL FIELD

The present disclosure relates to surface anomaly detecting devices, systems, methods, and non-transitory computer-readable media, and relates in particular to a surface anomaly detecting device, a system, a method, and a non-transitory computer-readable medium that can identify an anomalous portion on a surface of a complex structure.

### BACKGROUND ART

In a facility within an establishment, a deteriorated portion appearing in a surface of the facility's structure, such as a portion that has rusted or where the paint has peeled off due to aging or corrosion, is highly likely to lead to damage or corruption of the facility in the near future. Currently, such an anomalous portion on a surface is often identified and determined through visual inspection, but an inspector may miss an anomalous portion or makes a subjective determination, and also from the standpoint of workload of sending an inspector, the importance of a system for automatically identifying an anomalous portion is on the rise. A laser range-finding (Light Detection and Ranging (LiDAR)) device can acquire a three-dimensional structure of an object (a structure) and is often equipped with a function of measuring the luminance of the received laser light as well as the position information of points on the surface of the three-dimensional object. Typically, the luminance of received light, that is, the reflection luminance from an object is dependent on the condition of the surface of the object irradiated by a laser. Therefore, an anomalous portion on a surface, such as rusting or peeling of paint, can be detected by processing information indicating the luminance of received light acquired by a laser range-finding device. However, an attempt to identify an anomalous portion on a surface of a complex structure sometimes leads to a false detection or the like. In the present disclosure, the luminance of received light acquired by a laser range-finding device is referred to below as “reflection luminance.”

Patent Literature 1 discloses a surface defect detecting device that includes a feature amount calculating unit, a threshold setting unit, and a defect detecting unit. The feature amount calculating unit calculates a feature amount with respect to a luminance frequency distribution of an image obtained through imaging, based on the mean luminance, the standard deviation luminance, the maximum luminance, and the minimum luminance of the image. The threshold setting unit sets a luminance threshold based on the calculated feature amount. The defect detecting unit detects, based on the set threshold, a defective pixel in the image obtained through imaging.

Patent Literature 2 discloses a defect detecting device that acquires a plurality of pieces of image information of a target workpiece captured from respectively different positions, successively selects a portion on this workpiece as a portion of interest, compares the feature amount of the luminance of an image portion corresponding to the portion of interest in each of the plurality of pieces of image information, and determines whether there is a defect in the workpiece based on the result of the comparison.

### CITATION LIST

### Patent Literature

Patent Literature 1: Japanese Unexamined Patent Application Publication No. 2012-159376

Patent Literature 2: Japanese Unexamined Patent Application Publication No. 2013-195368

### SUMMARY OF INVENTION

### Technical Problem

As described above, there has been a problem that an anomalous portion on a surface of a complex structure is hard to identify. Neither Patent Literature 1 nor Patent Literature 2 discloses this problem, that is, discusses identification of an anomalous portion on a surface of a complex structure.

The present disclosure is directed to providing a surface anomaly detecting device, a system, a method, and a non-transitory computer-readable medium that each solve the problem described above.

### Solution to Problem

A surface anomaly detecting device according to the present disclosure includes:

dividing means configured to divide a structure into a plurality of clusters based on position information of a plurality of points on a surface of the structure;

coupling means configured to create a cluster group by coupling together two or more of the clusters;

determining means configured to determine a reflection luminance normal value of the cluster group based on a distribution of reflection luminance values at a plurality of points on a surface of the cluster group; and

identifying means configured to identify an anomalous portion on the surface of the cluster group based on a difference between the reflection luminance normal value and the reflection luminance value at each of the plurality of points on the surface of the cluster group.

A system according to the present disclosure includes:

a measuring device configured to acquire reflection luminance values at a plurality of points on a surface of a cluster group; and

a surface anomaly detecting device, wherein

the surface anomaly detecting device includes:
dividing means configured to divide a structure into a plurality of clusters based on position information of a plurality of points on a surface of the structure;
coupling means configured to create the cluster group by coupling together two or more of the clusters;
determining means configured to determine a reflection luminance normal value of the cluster group based on a distribution of the reflection luminance values at the plurality of points on the surface of the cluster group; and
identifying means configured to identify an anomalous portion on the surface of the cluster group based on a difference between the reflection luminance normal value and the reflection luminance value at each of the plurality of points on the surface of the cluster group, and

the surface anomaly detecting device is configured to identify the anomalous portion on the surface of the cluster group.

A method according to the present disclosure includes:

dividing a structure into a plurality of clusters based on position information of a plurality of points on a surface of the structure;

creating a cluster group by coupling together two or more of the clusters;

determining a reflection luminance normal value of the cluster group based on a distribution of reflection luminance values at a plurality of points on a surface of the cluster group; and

identifying an anomalous portion on the surface of the cluster group based on a difference between the reflection luminance normal value and the reflection luminance value at each of the plurality of points on the surface of the cluster group.

A non-transitory computer-readable medium according to the present disclosure stores a program that causes a computer to execute:

dividing a structure into a plurality of clusters based on position information of a plurality of points on a surface of the structure;

creating a cluster group by coupling together two or more of the clusters;

determining a reflection luminance normal value of the cluster group based on a distribution of reflection luminance values at a plurality of points on a surface of the cluster group; and

identifying an anomalous portion on the surface of the cluster group based on a difference between the reflection luminance normal value and the reflection luminance value at each of the plurality of points on the surface of the cluster group.

### Advantageous Effects of Invention

The present disclosure can provide a surface anomaly detecting device, a system, a method, and a non-transitory computer-readable medium that can identify an anomalous portion on a surface of a complex structure.

### BRIEF DESCRIPTION OF THE DRAWINGS

FIG. 1 is a block diagram illustrating an example of a surface anomaly detecting device according to a first example embodiment.

FIG. 2 is a block diagram illustrating an example of a system according to the first example embodiment.

FIG. 3 is a schematic diagram illustrating an example of a structure.

FIG. 4 is a schematic diagram illustrating an example of clusters.

FIG. 5 shows graphs each illustrating an example of a reflection luminance distribution of a cluster.

FIG. 6 show graphs illustrating an example of a reflection luminance distribution of a cluster group.

FIG. 7 is a flowchart illustrating an example of an operation of the surface anomaly detecting device according to the first example embodiment.

FIG. 8 illustrates an example of an angle of laser incidence according to a second example embodiment.

FIG. 9 is a flowchart illustrating an example of an operation of a surface anomaly detecting device according to the second example embodiment.

FIG. 10 illustrates an example of further division into cluster groups based on an angle of laser incidence according to a third example embodiment.

FIG. 11 is a flowchart illustrating an example of an operation of a surface anomaly detecting device according to the third example embodiment.

FIG. 12 is a schematic diagram illustrating a cluster group with no complementary point.

FIG. 13 is a schematic diagram illustrating a cluster group with complementary points.

FIG. 14 is a flowchart illustrating an example of an operation of a surface anomaly detecting device according to a fourth example embodiment.

FIG. 15 is a flowchart illustrating an example of an operation of a surface anomaly detecting device according to a modification example of the fourth example embodiment.

### DESCRIPTION OF EMBODIMENTS

Hereinafter, some example embodiments of the present invention will be described with reference to the drawings. In the drawings, identical or corresponding elements are given identical reference characters, and duplicate descriptions thereof will be omitted, as necessary, for the sake of making the description clearer.

### First Example Embodiment

An overview of a surface anomaly detecting device and a system according to a first example embodiment will be given.

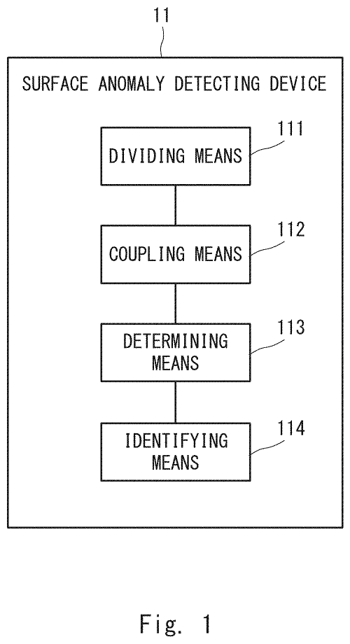

FIG. 1 is a block diagram illustrating an example of a surface anomaly detecting device according to the first example embodiment.

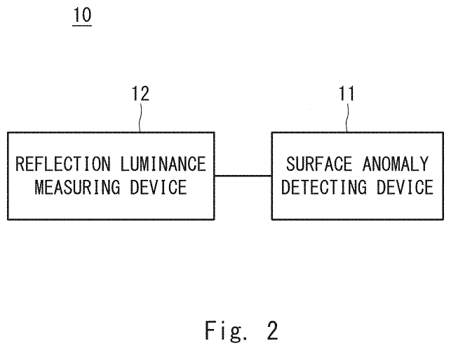

FIG. 2 is a block diagram illustrating an example of a system according to the first example embodiment.

As illustrated in FIG. 1, a surface anomaly detecting device 11 according to the first example embodiment includes a dividing means 111, a coupling means 112, a determining means 113, and an identifying means 114.

The dividing means 111 divides a structure into a plurality of portions, that is, into a plurality of clusters based on position information of a plurality of points on a surface of the structure. For the position information, for example, position information in three-dimensional coordinates is used.

The coupling means 112 creates a cluster group by coupling together two or more of the divided clusters.

The determining means 113 determines a reflection luminance normal value of the created cluster group based on the distribution of reflection luminance values at a plurality of points on a surface of the cluster group.

The identifying means 114 identifies an anomalous portion on the surface of the cluster group based on a difference between the determined reflection luminance normal value and the reflection luminance value at each of the plurality of points on the surface of the cluster group.

As illustrated in FIG. 2, a system 10 according to the first example embodiment includes a reflection luminance measuring device 12 and the surface anomaly detecting device 11.

The reflection luminance measuring device 12 has a distance measuring function and a reflection luminance measuring function. The distance measuring function is a function of irradiating a structure, serving as a measurement target, with laser light and acquiring three-dimensional distance data to the structure.

Meanwhile, the reflection luminance measuring function is a function of measuring the reflection luminance of laser light reflected from a structure. By using the distance measuring function and the reflection luminance measuring function, the reflection luminance measuring device 12 acquires position information, in the three-dimensional coordinates, of a plurality of points on a surface of a structure and the reflection luminance value at each of the positions. In other words, the reflection luminance measuring device 12 acquires the reflection luminance values at a plurality of points on a surface of a cluster group. In this manner, the reflection luminance measuring device 12 acquires position information, in the three-dimensional coordinates, of a plurality of points on a surface of a structure and the reflection luminance values at these positions. The position information, in the three-dimensional coordinates, of a plurality of points on a surface of a structure having a three-dimensional structure and the reflection luminance values at these points are referred to collectively as three-dimensional point cloud data.

The surface anomaly detecting device 11 acquires, from the reflection luminance measuring device 12, position information, in the three-dimensional coordinates, of a plurality of points on a surface of a structure and the corresponding reflection luminance values. The surface anomaly detecting device 11 identifies an anomalous portion on a surface of a cluster group based on the acquired reflection luminance values.

The surface anomaly detecting device according to the first example embodiment will be described in detail.

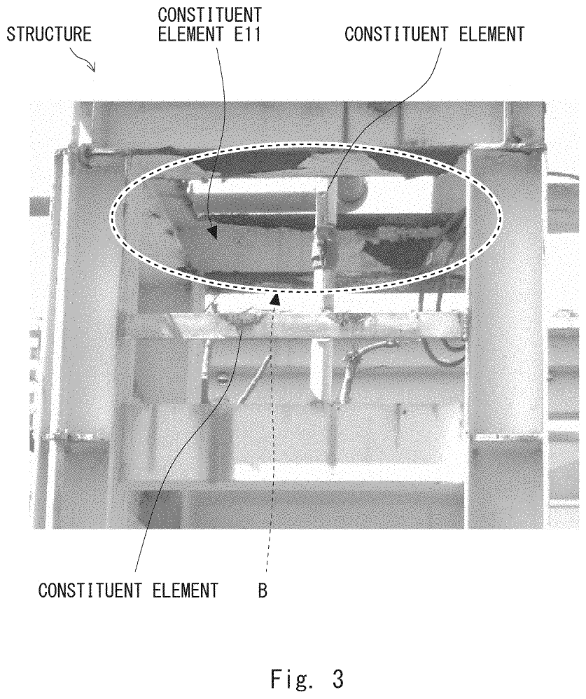

FIG. 3 is a schematic diagram illustrating an example of a structure.

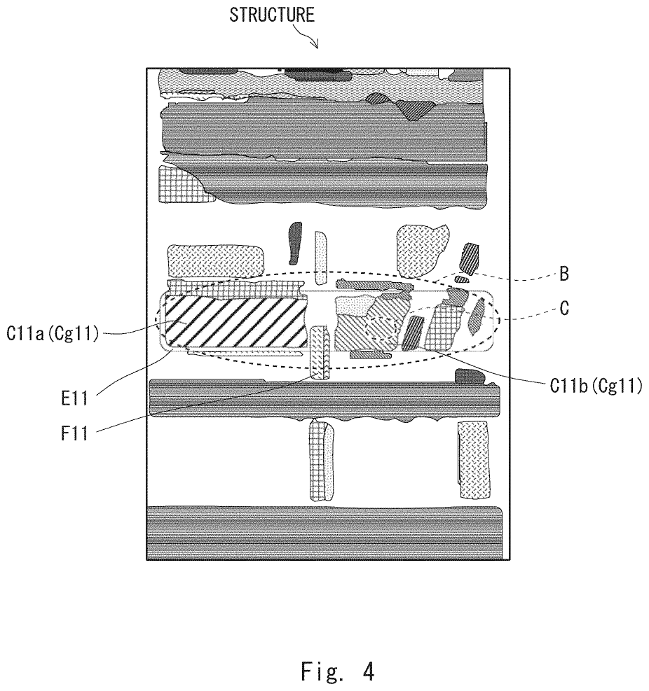

FIG. 4 is a schematic diagram illustrating an example of clusters.

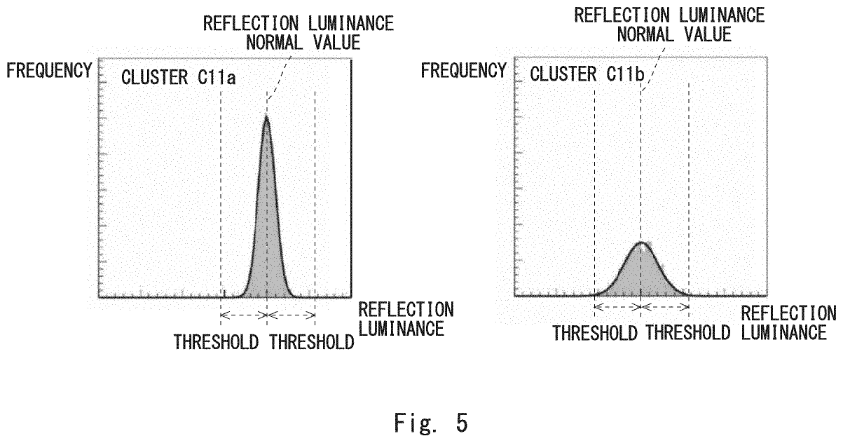

FIG. 5 shows graphs each illustrating an example of a reflection luminance distribution of a cluster.

In FIG. 5, the horizontal axis represents the reflection luminance, and the vertical axis represents the frequency.

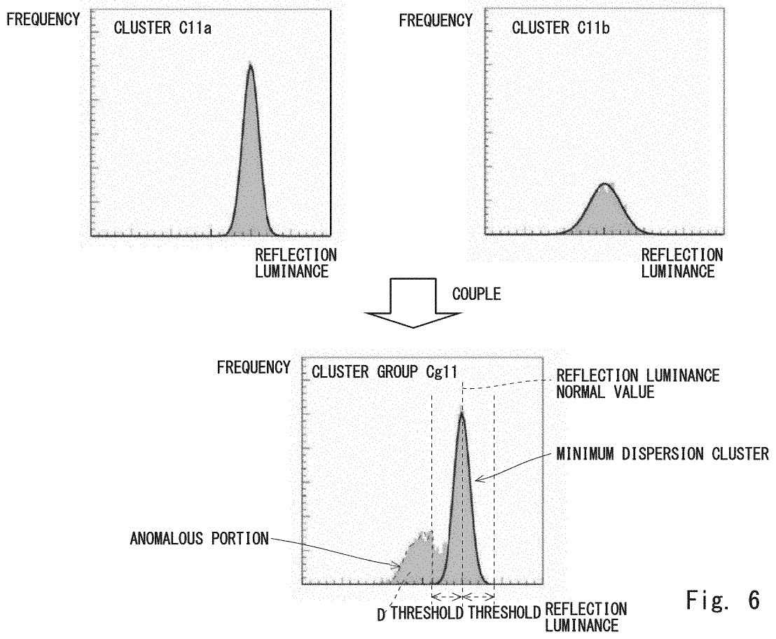

FIG. 6 shows graphs illustrating an example of a reflection luminance distribution of a cluster group.

In FIG. 6, the horizontal axis represents the reflection luminance, and the vertical axis represents the frequency.

As illustrated in FIG. 3, a structure includes a plurality of constituent elements. As illustrated in the section B in FIG. 3, the structure includes a constituent element E11 serving as one of the constituent elements of the structure. Information regarding the shape and so on of each constituent element of a structure can be acquired, for example as the same steel material, from a document such as a design plan.

As illustrated in FIG. 4, the surface anomaly detecting device 11 divides a structure into two or more clusters. In a case where a structure is complex, the constituent element E11 located further back is divided into a plurality of smaller clusters including a cluster C11a and a cluster C11b, for example, as illustrated in the section B in FIG. 4. In other words, the constituent element E11 is split into the cluster C11a and the cluster C11b by a constituent element F11 located in front of the constituent element E11.

As illustrated in FIG. 5, the reflection luminance distribution of the cluster C11a includes no reflection luminance value whose disparity from the reflection luminance normal value exceeds a threshold. Nor does the reflection luminance distribution of the cluster C11b include any reflection luminance value whose disparity from the reflection luminance normal value exceeds a threshold. Thus, neither the divided cluster C11a nor the divided cluster C11b includes an anomalous portion. In this manner, when one constituent element is divided into a plurality of clusters, there may be a case where an anomalous portion in the structure cannot be identified accurately. This occurs because, when the constituent element E11, or a single constituent element, is divided, the constituent element E11 has been divided into the cluster C11a and the cluster C11b.

Meanwhile, the coupling means 112 of the surface anomaly detecting device 11 according to the first example embodiment couples the cluster C11a and the cluster C11b to create a cluster group Cg11. When creating the cluster group Cg11, the coupling means 112 couples the cluster C11a and the cluster C11b if the resulting cluster group Cg11 is included in the constituent element E11. In other words, the coupling means 112 couples the cluster C11a and the cluster C11b if the shape of the constituent element E11 includes the shape of the resulting cluster group Cg11.

Specifically, the coupling means 112 acquires, in advance, information regarding the shape and so on of each constituent element of a structure. For example, the coupling means 112 acquires, in advance, a design plan and so on of a structure. The coupling means 112 compares the shape of a cluster group resulting from coupling together two or more clusters against the shapes of the constituent elements of the structure. In other words, the coupling means 112 compares the shape of the cluster group Cg11 against the shape of the constituent element E11. The coupling means 112 confirms the coupling of the cluster C11a and the cluster C11b if the shape of the constituent element E11 includes the shape of the cluster group Cg11.

As a result, the surface anomaly detecting device 11 acquires a reflection luminance distribution of the cluster group Cg11 such as the one illustrated in FIG. 6. The determining means 113 determines a reflection luminance normal value of the cluster group Cg11 based on the distribution of reflection luminance values at a plurality of points on a surface of the cluster group Cg11.

The determining means 113 determines, of the distribution of the reflection luminance values of the cluster group Cg11, the reflection luminance value with the highest frequency as the reflection luminance normal value, for example.

In addition, the determining means 113 identifies, of the distribution of the reflection luminance values of the cluster group Cg11, the cluster with the smallest dispersion as a minimum dispersion cluster. The determining means 113 may determine, of the distribution of the reflection luminance values of the identified minimum dispersion cluster, the reflection luminance value with the highest frequency as the reflection luminance normal value.

The identifying means 114 identifies, of a plurality of points on a surface of the cluster group Cg11, a predetermined point where the difference between its reflection luminance value and the reflection luminance normal value exceeds a threshold as an anomalous portion. For example, the reflection luminance of the section C illustrated in FIG. 4 is indicated as the section D in FIG. 6, and the section C is identified with some points on the surface of the cluster group Cg11 identified as an anomalous portion. In this manner, one of the features of the surface anomaly detecting device 11 is to form a cluster group by coupling clusters that can be regarded as belonging to the same constituent element and to identify an anomalous portion based on the cluster group.

The surface anomaly detecting device 11 according to the first example embodiment divides a structure into clusters and then creates a cluster group by coupling together two or more of the clusters. The surface anomaly detecting device 11 according to the first example embodiment further identifies an anomalous portion on a surface of the structure based on the distribution of reflection luminance values at a plurality of points on a surface of the created cluster group. With this configuration, as compared to a case where the distribution of reflection luminance values of a cluster is used, an anomalous portion can be identified more accurately particularly in a complex structure.

Consequently, with the surface anomaly detecting device 11 according to the first example embodiment, a surface anomaly detecting device and a system that can identify an anomalous portion on a surface of a complex structure can be provided. Moreover, with the surface anomaly detecting device 11, an anomalous portion, that is, a portion that needs repairing can be identified, and thus the repair can be made promptly.

Meanwhile, it is difficult to identify an anomalous portion accurately also when a structure is dissected (divided) finely into small clusters and when there is only a small number of points on the surface of each cluster. In such a case, the coupling means 112 may create a cluster group Cg11 by coupling a small cluster having no more than a predetermined number of points on its surface and an adjacent cluster adjacent to the small cluster.

An operation of the surface anomaly detecting device according to the first example embodiment will be described.

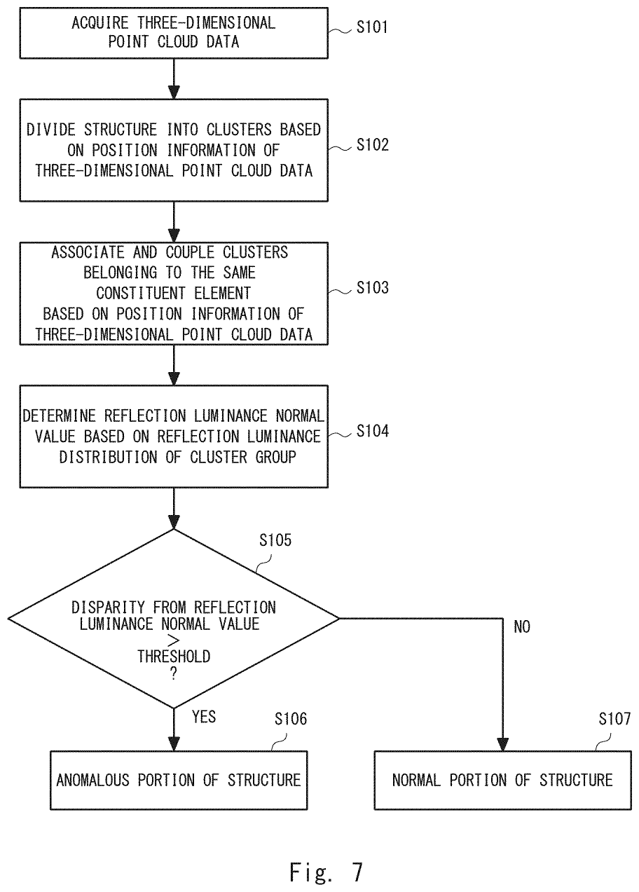

FIG. 7 is a flowchart illustrating an example of an operation of the surface anomaly detecting device according to the first example embodiment.

As illustrated in FIG. 7, the surface anomaly detecting device 11 acquires three-dimensional point cloud data of a structure (step S101). Position information, in the three-dimensional coordinates, of a plurality of points on a surface of a structure having a three-dimensional structure and the reflection luminance values at these points will be referred to collectively as three-dimensional point cloud data. A plurality of points will be referred to as a point cloud.

The surface anomaly detecting device 11 divides the structure into clusters based on the position information of the three-dimensional point cloud data (step S102).

The surface anomaly detecting device 11 associates and couples clusters that belong to the same constituent element based on the position information of the three-dimensional point cloud data of the divided clusters (step S103). In the example of the structure illustrated in FIG. 4, the cluster C11a and the cluster C11b both belong to the constituent element E11. Therefore, the surface anomaly detecting device 11 couples the cluster C11a and the cluster C11b and creates the cluster group Cg11.

The surface anomaly detecting device 11 determines a reflection luminance normal value of the cluster group based on the distribution of reflection luminance values at a plurality of points on a surface of the cluster group (step S104).

If the disparity of the reflection luminance value from the reflection luminance normal value in a point cloud exceeds a threshold (step S105: Yes), the surface anomaly detecting device 11 determines this point cloud as an anomalous portion of the structure (step S106). In other words, if the difference between the reflection luminance normal value and the reflection luminance value at a predetermined point, among a plurality of points on the surface of the cluster group, exceeds a threshold, the surface anomaly detecting device 11 determines this predetermined point as an anomalous portion of the structure.

If the disparity of the reflection luminance value from the reflection luminance normal value in the point cloud is no greater than the threshold (step S105: No), the surface anomaly detecting device 11 determines this point cloud as a normal portion of the structure (step S107). In other words, if the difference between the reflection luminance normal value and the reflection luminance value at a predetermined point, among a plurality of points on the surface of the cluster group, is no greater than the threshold, the surface anomaly detecting device 11 determines this predetermined point as a normal portion of the structure.

### Second Example Embodiment

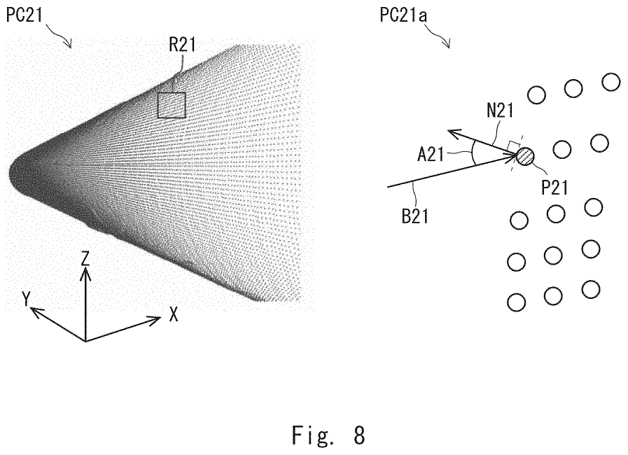

FIG. 8 illustrates an example of an angle of laser incidence according to a second example embodiment.

A surface anomaly detecting device 21 according to the second example embodiment differs from the surface anomaly detecting device 11 according to the first example embodiment in that the surface anomaly detecting device 21 corrects reflection luminance values in accordance with the angle of laser incidence at each point on a surface of a cluster group (a structure).

The angular dependence of the reflection luminance value with respect to reflected laser light changes in accordance with the properties of a surface of a structure. Therefore, when a structure has a curved surface, an anomalous portion in the surface of the structure can be identified with higher accuracy by correcting the reflection luminance value in accordance with the angle of laser incidence.

A point cloud PC21a illustrated in FIG. 8 is an enlargement of a point cloud within a three-dimensional region R21 in a point cloud PC21. The point cloud PC21 will be described with an example of a cylindrical constituent element.

As illustrated in FIG. 8, a range-finding point P21 is one of a plurality of points on a surface of a cluster group of a structure, and an angle of laser incidence A21 at the range-finding point P21 is calculated (estimated) based on a direction of laser incidence B21 connecting the range-finding point P21 in the cluster group and an observation point (the surface anomaly detecting device 21 or the reflection luminance measuring device 12) and the direction of a normal N21 at the range-finding point P21 in the cluster group. In other words, the angle of laser incidence A21 is calculated as an angle formed by the direction of laser incidence B21 and the direction of the normal N21. The normal N21 is calculated by use of a plurality of range-finding points surrounding the range-finding point P21.

The surface anomaly detecting device 21 corrects the reflection luminance value at the range-finding point P21 based on the angle of laser incidence A21. For example, in the case of Lambert reflection, the relationship indicated in the expression (1) holds among a measured value L of the reflection luminance, the angle of laser incidence A21, and a correction value L1.

L1∝(L/cos (A21)) (1)

Therefore, the reflection luminance value at each point is corrected in accordance with the angle of laser incidence A21 based on the expression (1).

In correcting the reflection luminance value, a reflectance model based on Lambert reflection may be created, and the reflection luminance value may be corrected based on this reflectance model. Alternatively, the reflection luminance value may be corrected based on the characteristics of the reflectance measured in advance.

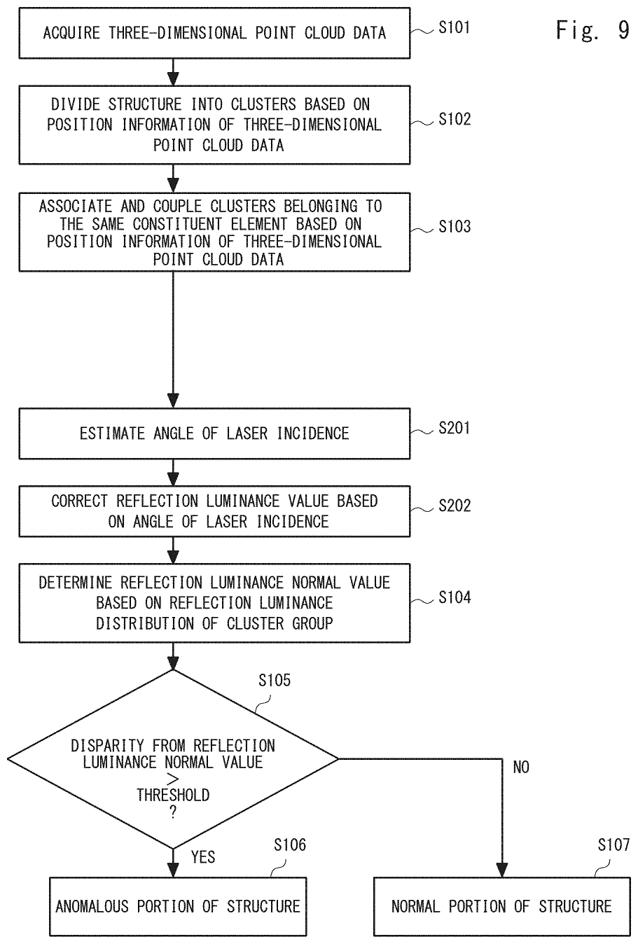

FIG. 9 is a flowchart illustrating an example of an operation of the surface anomaly detecting device according to the second example embodiment.

As illustrated in FIG. 9, the operation of the surface anomaly detecting device 21 differs from the operation of the surface anomaly detecting device 11 (see FIG. 7) in that step S201 and step S202 are added between step S103 and step S104. The operation covering from step S101 to step S103 and the operation covering from step S104 to step S107 are identical to those in the operation of the surface anomaly detecting device 11. Therefore, only the operations in step

S201 and step S202 will be described.

After step S103, the surface anomaly detecting device 21 estimates the angle of laser incidence A21 based on the direction of laser incidence at each point on the surface of the cluster group of the structure and the normal N21 at each point (step S201).

The surface anomaly detecting device 21 corrects the reflection luminance value at each point (each range-finding point) based on the estimated angle of laser incidence A21 (step S202). The reflection luminance value may be corrected based on the reflectance model that is based on Lambert reflection or based on the characteristics of the reflectance measured in advance.

After step S202, step S104 to step S107 are performed in a manner similar to that according to the first example embodiment.

In this example described above, step S201 and step S202 are performed between steps S103 and step S104, but this is not a limiting example. There is no limitation on the order of the processes as long as the condition that step S201 and step S202 be performed before step S104 is satisfied.

In this manner, as compared with the surface anomaly detecting device 11 according to the first example embodiment, the surface anomaly detecting device 21 according to the second example embodiment can identify an anomalous portion in a surface of particularly a curved structure with higher accuracy.

### Third Example Embodiment

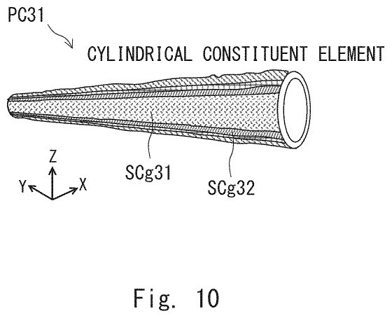

FIG. 10 illustrates an example of further division into cluster groups based on an angle of laser incidence according to a third example embodiment.

A point cloud PC31 illustrated in FIG. 10 is a point cloud on a surface of a cylindrical constituent element of a structure.

A surface anomaly detecting device 31 according to the third example embodiment differs from the surface anomaly detecting device 11 according to the first example embodiment in that a point cloud within a cluster is further separated into point clouds each with the same angle of laser incidence and then an anomalous portion is identified. The point cloud PC31 will be described with an example of a cylindrical constituent element.

As illustrated in FIG. 10, the surface anomaly detecting device 31 according to the third example embodiment further divides a cluster group into subcluster groups based on the angle of laser incidence. Specifically, a cluster group is divided into groups each having the same or similar angle of incidence, such as into a subcluster group SCg31 and a subcluster group SCg32.

The surface anomaly detecting device 31 determines a reflection luminance normal value of a subcluster group based on the distribution of reflection luminance values at a plurality of points on a surface of the subcluster group.

The surface anomaly detecting device 31 identifies an anomalous portion on a surface of a subcluster group based on a difference between the reflection luminance normal value of the subcluster group and the reflection luminance value at each of a plurality of points on the surface of the subcluster group. In this manner, the surface anomaly detecting device 31 identifies an anomalous portion on a surface of a subcluster group based on the reflection luminance value of each subcluster group.

An operation of the surface anomaly detecting device 31 according to the third example embodiment will be described.

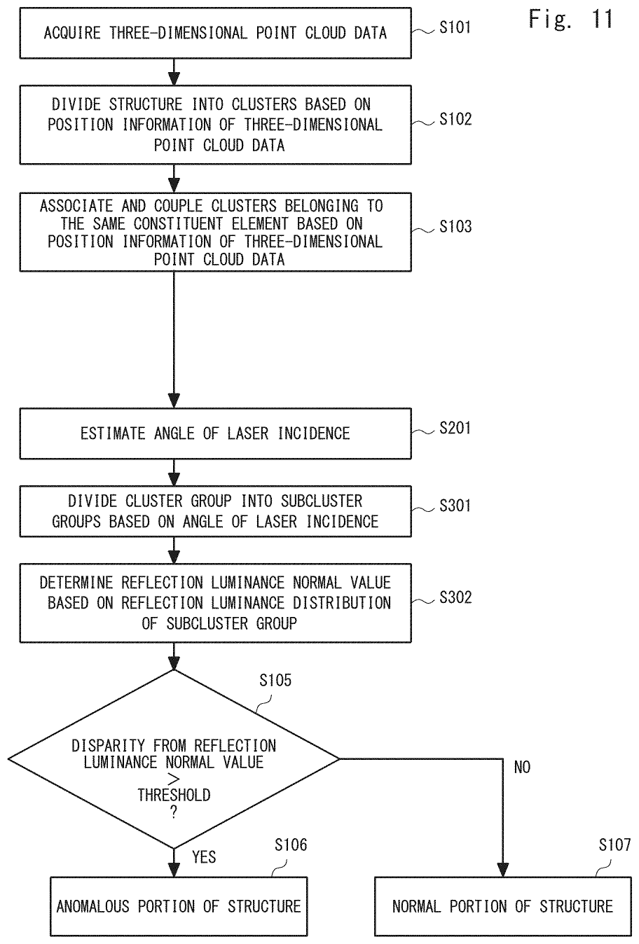

FIG. 11 is a flowchart illustrating an example of an operation of the surface anomaly detecting device according to the third example embodiment.

As illustrated in FIG. 11, step S101 to step S103 are performed in a manner similar to that according to the first example embodiment. After step S103, step S201 is performed in a manner similar to that according to the second example embodiment.

After step S201, the surface anomaly detecting device 31 further divides the cluster group into subcluster groups based on the angle of laser incidence (step S301). The surface anomaly detecting device 31 further divides the cluster group into subcluster groups per predetermined angular range of the angle of laser incidence.

The cluster group may be divided into subcluster groups per fixed range of the angle of laser incidence.

The surface anomaly detecting device 31 determines the reflection luminance normal value of a subcluster group based on the distribution of reflection luminance values at a plurality of points on a surface of the subcluster group (step S302). In other words, the surface anomaly detecting device 31 determines the normal value of the reflection luminance of a subcluster group that is a point cloud divided from a single cluster group and identified to have the same angle of laser incidence, based on the reflection luminance distribution of the subcluster group.

After step S302, step S105 to step S107 are performed in a manner similar to that according to the first example embodiment.

In this manner, the surface anomaly detecting device 31 identifies an anomalous portion on a surface of a subcluster group based on a difference between the reflection luminance normal value of the subcluster group and the reflection luminance value at each of a plurality of points on the surface of the subcluster group.

In this example described above, step S201 is performed between step S103 and step S301, but this is not a limiting example. There is no limitation on the order of the processes as long as the condition that step S201 be performed before step S301 is satisfied.

In this manner, as compared with the surface anomaly detecting device 11 according to the first example embodiment, the surface anomaly detecting device 31 according to the third example embodiment can identify an anomalous portion on a surface of particularly a curved structure with higher accuracy.

### Fourth Example Embodiment

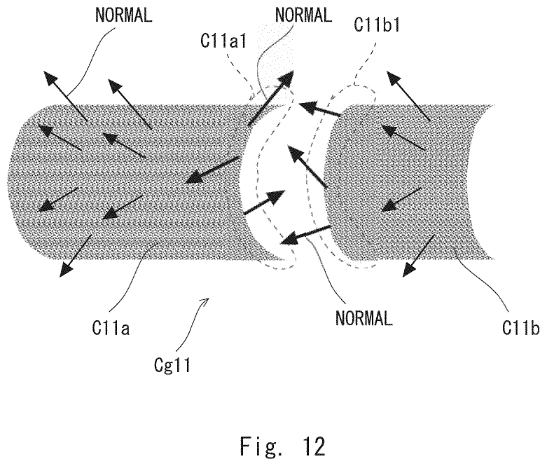

FIG. 12 is a schematic diagram illustrating a cluster group with no complementary point.

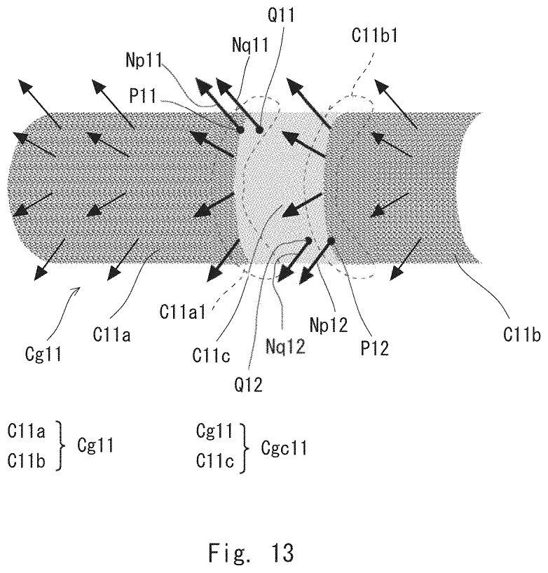

FIG. 13 is a schematic diagram illustrating a cluster group with complementary points.

As illustrated in FIG. 12, when a structure is divided into a plurality of clusters, such as a cluster C11a and a cluster C11b, a large error arises in the estimated value of the angle of laser incidence in the cluster C11a alone or the cluster C11b alone. In particular, the number of points surrounding one end portion C11a1 of the cluster C11a or one end portion C11b1 of the cluster C11b is not sufficient, and thus an error arises in the normal at range-finding points. In this example, the cluster C11a may also be referred to as a first cluster, and the cluster C11b may also be referred to as a second cluster.

The angle of laser incidence is estimated based on the direction of laser incidence at a range-finding point in a cluster group and the direction of the normal at the range-finding point in the cluster group. Therefore, an error in the normal leads to an error in the angle of laser incidence. Since the reflection luminance value at a range-finding point in a cluster group is corrected based on the angle of laser incidence, an accurate normal needs to be estimated in order to estimate the angle of laser incidence accurately.

Accordingly, as illustrated in FIG. 13, a surface anomaly detecting device 41 according to a fourth example embodiment generates complementary points between clusters (between the cluster C11a and the cluster C11b) and estimates the angle of laser incidence accurately by use of the complementary points.

Specifically, the surface anomaly detecting device 41 further includes a complementing means (not illustrated). The complementing means calculates a plurality of complementary points that fill between the cluster C11a that is one cluster in a cluster group and the cluster C11b closest to the cluster C11a. The complementing means creates a complementary cluster C11c having a plurality of complementary points on its surface. In other words, the complementing means creates the complementary cluster C11c so as to connect the one end portion C11a1 and the one end portion C11b1. The surface anomaly detecting device 41 creates a complementary cluster group Cgc11 by coupling the cluster group Cg11 and the complementary cluster C11c.

At this point, the direction of the normal at a complementary point is estimated based on the directions of the normal at a plurality of range-finding points surrounding the complementary point. In other words, the normal is calculated and estimated from the positional relationship to the surrounding point cloud. The surface anomaly detecting device 41 identifies an anomalous portion of a structure by use of the complementary cluster group Cgc11 instead of the cluster group Cg11.

According to the fourth example embodiment, the added complementary points increase the number of surrounding points at the one end portion C11a1 of the cluster C11a. Thus, the normal at a range-finding point is estimated accurately, and in turn the angle of incidence is estimated accurately. The reflection luminance value at a range-finding point in a cluster group is corrected accurately based on the accurate angle of laser incidence.

Meanwhile, as illustrated in FIG. 13, the direction of a normal Np11 at a range-finding point P11 on the one end portion C11a1 of the cluster C11a facing the cluster C11b may extend in the same direction as the direction of a normal Nq11 at a complementary point Q11 closest to the range-finding point P11. In addition, the direction of a normal Np12 at a range-finding point P12 on the one end portion C11b1 of the cluster C11b facing the cluster C11a may extend in the same direction as the direction of a normal Nq12 at a complementary point Q12 closest to the range-finding point P12. In this example, the range-finding point P11 may also be referred to as a first range-finding point, and the range-finding point P12 may also be referred to as a second range-finding point.

The direction of the normal Nq11 at the complementary point Q11 may be estimated by averaging the directions of normal at a plurality of range-finding points surrounding the complementary point Q11. In a similar manner, the direction of the normal Nq12 at the complementary point Q12 may be estimated by averaging the directions of normal at a plurality of range-finding points surrounding the complementary point Q12.

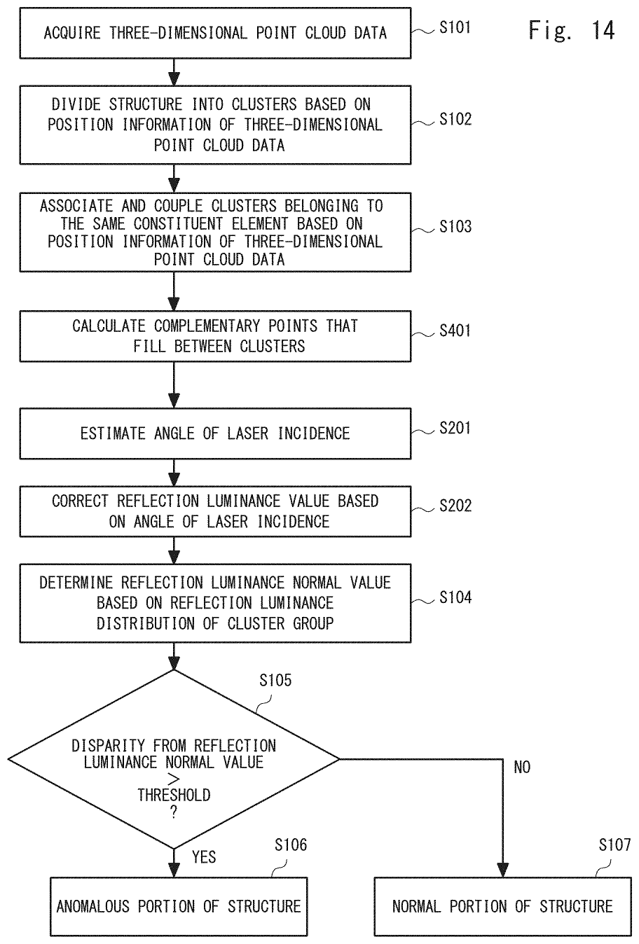

FIG. 14 is a flowchart illustrating an example of an operation of the surface anomaly detecting device according to the fourth example embodiment.

As illustrated in FIG. 14, the operation of the surface anomaly detecting device 41 according to the fourth example embodiment differs from the operation of the surface anomaly detecting device 21 according to the second example embodiment (see FIG. 9) in that step S401 is added between step S103 and step S201.

As illustrated in FIG. 14, step S101 to step S103 are performed in a manner similar to that according to the first example embodiment.

After step S103, the surface anomaly detecting device 41 calculates a plurality of complementary points that fill between the cluster C11a and the cluster C11b closest to the cluster C11a (between the clusters) (step S401).

After step S401, step S201 to step S107 are performed in a manner similar to that according to the first example embodiment or the second example embodiment.

### Modification Example of Fourth Example Embodiment

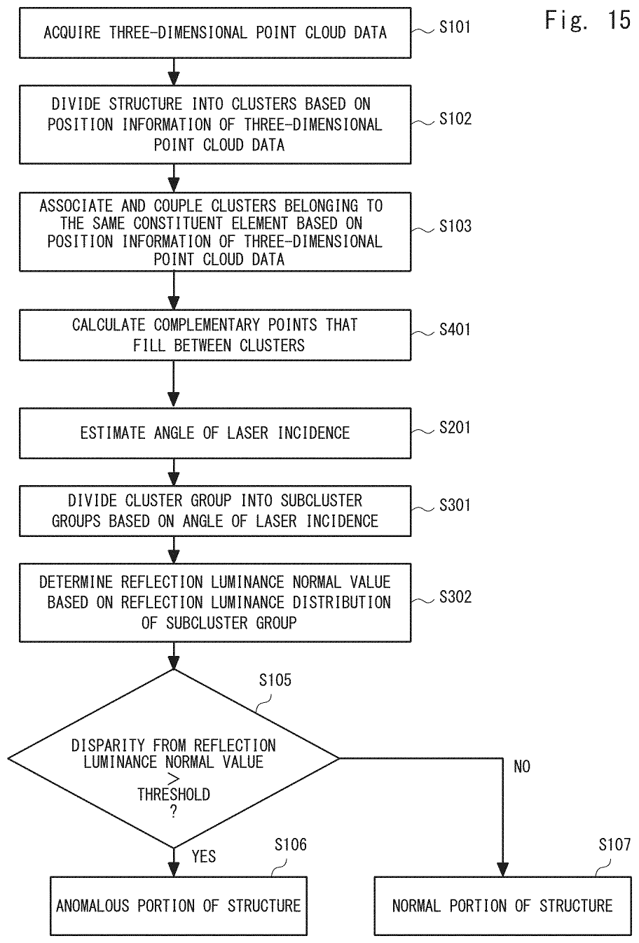

FIG. 15 is a flowchart illustrating an example of an operation of a surface anomaly detecting device according to a modification example of the fourth example embodiment.

As illustrated in FIG. 15, the operation of a surface anomaly detecting device 41 according to a modification example of the fourth example embodiment differs from the operation of the surface anomaly detecting device 31 according to the third example embodiment (see FIG. 11) in that step S401 is added between step S103 and step S201.

As illustrated in FIG. 15, step S101 to step S103 are performed in a manner similar to that according to the first example embodiment.

Step S401 is performed in a manner similar to that according to the fourth example embodiment.

After step S401, step S201 to step S107 are performed in a manner similar to that according to the first example embodiment or the third example embodiment.

In this manner, since the surface anomaly detecting device 41 according to the fourth example embodiment fills between clusters, as compared with the surface anomaly detecting devices according to the other example embodiments, the surface anomaly detecting device 41 can identify an anomalous portion on a surface of a structure with higher accuracy.

According to the foregoing example embodiments, the present invention has been described as a configuration of hardware, but the present invention is not limited thereto. According to the present invention, the processes of the constituent elements can also be implemented as a central processing unit (CPU) executes a computer program.

In the foregoing example embodiments, the program can be stored and provided to a computer by use of various types of non-transitory computer-readable media. The non-transitory computer-readable media include various types of tangible storage media. Examples of such non-transitory computer-readable media include a magnetic recording medium (specifically, a flexible disk, a magnetic tape, a hard-disk drive), a magneto-optical recording medium (specifically, a magneto-optical disk), a CD-ROM (read-only memory), a CD-R, a CD-R/W, and a semiconductor memory (specifically, a mask ROM, a programmable ROM (PROM), an erasable PROM (EPROM), a flash ROM, a random-access memory (RAM)). The program may also be supplied to a computer by use of various types of transitory computer-readable media. Examples of such transitory computer-readable media include an electric signal, an optical signal, and an electromagnetic wave. A transitory computer-readable medium can supply the program to a computer via a wired communication line, such as an electric wire or an optical fiber, or via a wireless communication line.

Thus far, the invention of the present application has been described with reference to some example embodiments, but the invention of the present application is not limited by the foregoing example embodiments. Various modifications that a person skilled in the art can appreciate can be made to the configurations and the details of the invention of the present application within the scope of the invention.

The present invention is not limited to the foregoing example embodiments, and modifications can be made, as appropriate, within the scope that does not depart from the spirit of the present invention.

A part or the whole of the foregoing example embodiments can also be expressed as in the following supplementary notes, which are not limiting.

### (Supplementary Note 1)

A surface anomaly detecting device comprising:

dividing means configured to divide a structure into a plurality of clusters based on position information of a plurality of points on a surface of the structure;

coupling means configured to create a cluster group by coupling together two or more of the clusters;

determining means configured to determine a reflection luminance normal value of the cluster group based on a distribution of reflection luminance values at a plurality of points on a surface of the cluster group; and

identifying means configured to identify an anomalous portion on the surface of the cluster group based on a difference between the reflection luminance normal value and the reflection luminance value at each of the plurality of points on the surface of the cluster group.

### (Supplementary Note 2)

The surface anomaly detecting device according to Supplementary note 1, wherein the identifying means is configured to identify, among the plurality of points on the surface of the cluster group, a predetermined point where the difference between the reflection luminance value and the reflection luminance normal value exceeds a threshold as the anomalous portion.

### (Supplementary Note 3)

The surface anomaly detecting device according to Supplementary note 1 or 2, wherein the coupling means is configured to couple the clusters if the cluster group is included in a constituent element of the structure.

### (Supplementary Note 4)

The surface anomaly detecting device according to Supplementary note 1 or 2, wherein the coupling means is configured to create the cluster group by coupling a small cluster having no more than a predetermined number of points on a surface thereof and an adjacent cluster adjacent to the small cluster.

### (Supplementary Note 5)

The surface anomaly detecting device according to any one of Supplementary notes 1 to 4, wherein the determining means is configured to determine, of the distribution of the reflection luminance values of the cluster group, the reflection luminance value with a highest frequency as the reflection luminance normal value.

### (Supplementary Note 6)

The surface anomaly detecting device according to any one of Supplementary notes 1 to 4, wherein the determining means is configured to

identify, of the distribution of the reflection luminance values of the cluster group, a minimum dispersion cluster with a smallest dispersion, and

determine, of the distribution of the reflection luminance values of the minimum dispersion cluster, the reflection luminance value with a highest frequency as the reflection luminance normal value.

### (Supplementary Note 7)

The surface anomaly detecting device according to any one of Supplementary notes 1 to 6, wherein

an angle of laser incidence at a range-finding point that is one of the plurality of points on the surface of the cluster group is calculated based on a direction connecting the range-finding point of the cluster group with the surface anomaly detecting device and a direction of a normal at the range-finding point of the cluster group, and

the reflection luminance value at the range-finding point of the cluster group is corrected based on the angle of laser incidence.

### (Supplementary Note 8)

The surface anomaly detecting device according to any one of Supplementary notes 1 to 7, wherein

an angle of laser incidence at a range-finding point that is one of the plurality of points on the surface of the cluster group is calculated based on a direction connecting the range-finding point of the cluster group with the surface anomaly detecting device and a direction of a normal at the range-finding point of the cluster group,

the dividing means is configured to further divide the cluster group into subcluster groups based on the angle of laser incidence,

the determining means is configured to determine a reflection luminance normal value of the subcluster group based on a distribution of reflection luminance values at a plurality of points on a surface of the subcluster group, and

the identifying means is configured to identify an anomalous portion on the surface of the subcluster group based on a difference between the reflection luminance normal value of the subcluster group and the reflection luminance value at each of the plurality of points on the surface of the subcluster group.

### (Supplementary Note 9)

The surface anomaly detecting device according to Supplementary note 7 or 8, further comprising:

complementing means configured to calculate a plurality of complementary points that fill a space between a first cluster that is one of the clusters in the cluster group and a second cluster closest to the first cluster and create a complementary cluster having the plurality of complementary points on a surface thereof, wherein

the coupling means is configured to create a complementary cluster group by coupling the cluster group with the complementary cluster,

a direction of a normal at the complementary point is estimated based on directions of normal at a plurality of the range-finding points surrounding the complementary point, and

the anomalous portion of the structure is identified by use of the complementary cluster group instead of the cluster group.

### (Supplementary Note 10)

The surface anomaly detecting device according to Supplementary note 9, wherein

a direction of a normal at a first range-finding point on one end portion of the first cluster facing the second cluster extends in the same direction as a direction of a normal at the complementary point closest to the first range-finding point, and

a direction of a normal at a second range-finding point on one end portion of the second cluster facing the first cluster extends in the same direction as a direction of a normal at the complementary point closest to the second range-finding point.

### (Supplementary Note 11)

The surface anomaly detecting device according to Supplementary note 9 or 10, wherein the direction of the normal at the complementary point is estimated by averaging directions of normal at a plurality of the range-finding points surrounding the complementary point.

### (Supplementary Note 12)

A system comprising:

a measuring device configured to acquire the reflection luminance values at a plurality of points on a surface of the cluster group; and

the surface anomaly detecting device according to any one of Supplementary notes 1 to 11,

wherein the surface anomaly detecting device is configured to identify the anomalous portion on the surface of the cluster group.

### (Supplementary Note 13)

A method comprising:

dividing a structure into a plurality of clusters based on position information of a plurality of points on a surface of the structure;

creating a cluster group by coupling together two or more of the clusters;

determining a reflection luminance normal value of the cluster group based on a distribution of reflection luminance values at a plurality of points on a surface of the cluster group; and

identifying an anomalous portion on the surface of the cluster group based on a difference between the reflection luminance normal value and the reflection luminance value at each of the plurality of points on the surface of the cluster group.

### (Supplementary Note 14)

A non-transitory computer-readable medium storing a program that causes a computer to execute:

dividing a structure into a plurality of clusters based on position information of a plurality of points on a surface of the structure;

creating a cluster group by coupling together two or more of the clusters;

determining a reflection luminance normal value of the cluster group based on a distribution of reflection luminance values at a plurality of points on a surface of the cluster group; and

identifying an anomalous portion on the surface of the cluster group based on a difference between the reflection luminance normal value and the reflection luminance value at each of the plurality of points on the surface of the cluster group.

### REFERENCE SIGNS LIST

10: system

11, 21, 31, 41: surface anomaly detecting device

111: dividing means

112: coupling means

113: determining means

114: identifying means

12: reflection luminance measuring device

E11, F11: constituent element

C11a, C11b: cluster

C11a1, C11b1: one end portion

C11c: complementary cluster

Cg11: cluster group

Cgc11: complementary cluster group

SCg31, SCg32: subcluster group

PC21, PC21a, PC31: point cloud

R21: three-dimensional region

P11, P12, P21: range-finding point

A21: angle of laser incidence

B21: direction of laser incidence

Np11, Nq11, N21: normal

L: measured value

L1: correction value

B, C, D: section

What is claimed is:

1. A surface anomaly detecting device comprising:
at least one memory storing instructions, and at least one processor configured to execute the instructions to;
divide a structure into a plurality of clusters based on position information of a plurality of points on a surface of the structure;
create a cluster group by coupling together two or more of the clusters;
determine a reflection luminance normal value of the cluster group based on a distribution of reflection luminance values at a plurality of points on a surface of the cluster group; and
identify an anomalous portion on the surface of the cluster group based on a difference between the reflection luminance normal value and the reflection luminance value at each of the plurality of points on the surface of the cluster group.

2. The surface anomaly detecting device according to claim 1, wherein the at least one processor is configured to identify, among the plurality of points on the surface of the cluster group, a predetermined point where the difference between the reflection luminance value and the reflection luminance normal value exceeds a threshold as the anomalous portion.

3. The surface anomaly detecting device according to claim 1, wherein the at least one processor is configured to couple the clusters if the cluster group is included in a constituent element of the structure.

4. The surface anomaly detecting device according to claim 1, wherein the at least one processor is configured to create the cluster group by coupling a small cluster having no more than a predetermined number of points on a surface thereof and an adjacent cluster adjacent to the small cluster.

5. The surface anomaly detecting device according to claim 1, wherein the at least one processor is configured to determine, of the distribution of the reflection luminance values of the cluster group, the reflection luminance value with a highest frequency as the reflection luminance normal value.

6. The surface anomaly detecting device according to claim 1, wherein the at least one processor is configured to
identify, of the distribution of the reflection luminance values of the cluster group, a minimum dispersion cluster with a smallest dispersion, and
determine, of the distribution of the reflection luminance values of the minimum dispersion cluster, the reflection luminance value with a highest frequency as the reflection luminance normal value.

7. The surface anomaly detecting device according to claim 1, wherein
an angle of laser incidence at a range-finding point that is one of the plurality of points on the surface of the cluster group is calculated based on a direction connecting the range-finding point of the cluster group with the surface anomaly detecting device and a direction of a normal at the range-finding point of the cluster group, and
the reflection luminance value at the range-finding point of the cluster group is corrected based on the angle of laser incidence.

8. The surface anomaly detecting device according to claim 1, wherein
an angle of laser incidence at a range-finding point that is one of the plurality of points on the surface of the cluster group is calculated based on a direction connecting the range-finding point of the cluster group with the surface anomaly detecting device and a direction of a normal at the range-finding point of the cluster group,
the at least one processor is configured to further divide the cluster group into subcluster groups based on the angle of laser incidence,
the at least one processor is configured to determine a reflection luminance normal value of the subcluster group based on a distribution of reflection luminance values at a plurality of points on a surface of the subcluster group, and
the at least one processor is configured to identify an anomalous portion on the surface of the subcluster group based on a difference between the reflection luminance normal value of the subcluster group and the reflection luminance value at each of the plurality of points on the surface of the subcluster group.

9. The surface anomaly detecting device according to claim 7, further comprising:
the at least one processor configured to calculate a plurality of complementary points that fill a space between a first cluster that is one of the clusters in the cluster group and a second cluster closest to the first cluster and create a complementary cluster having the plurality of complementary points on a surface thereof, wherein
the at least one processor is configured to create a complementary cluster group by coupling the cluster group with the complementary cluster,
a direction of a normal at the complementary point is estimated based on directions of normal at a plurality of the range-finding points surrounding the complementary point, and
the anomalous portion of the structure is identified by use of the complementary cluster group instead of the cluster group.

10. The surface anomaly detecting device according to claim 9, wherein
a direction of a normal at a first range-finding point on one end portion of the first cluster facing the second cluster extends in the same direction as a direction of a normal at the complementary point closest to the first range-finding point, and
a direction of a normal at a second range-finding point on one end portion of the second cluster facing the first cluster extends in the same direction as a direction of a normal at the complementary point closest to the second range-finding point.

11. The surface anomaly detecting device according to claim 9, wherein the direction of the normal at the complementary point is estimated by averaging directions of normal at a plurality of the range-finding points surrounding the complementary point.

12. A system comprising:
a measuring device configured to acquire the reflection luminance values at a plurality of points on a surface of the cluster group; and
the surface anomaly detecting device according to claim 1,
wherein the surface anomaly detecting device is configured to identify the anomalous portion on the surface of the cluster group.

13. A method comprising:
dividing a structure into a plurality of clusters based on position information of a plurality of points on a surface of the structure;
creating a cluster group by coupling together two or more of the clusters;
determining a reflection luminance normal value of the cluster group based on a distribution of reflection luminance values at a plurality of points on a surface of the cluster group; and
identifying an anomalous portion on the surface of the cluster group based on a difference between the reflection luminance normal value and the reflection luminance value at each of the plurality of points on the surface of the cluster group.

14. A program that causes a computer to execute:
dividing a structure into a plurality of clusters based on position information of a plurality of points on a surface of the structure;
creating a cluster group by coupling together two or more of the clusters;
determining a reflection luminance normal value of the cluster group based on a distribution of reflection luminance values at a plurality of points on a surface of the cluster group; and
identifying an anomalous portion on the surface of the cluster group based on a difference between the reflection luminance normal value and the reflection luminance value at each of the plurality of points on the surface of the cluster group.
